(19) United States
(12) Patent Application Publication
(10) Pub. No.: US 2024/0035487 A1
(43) Pub. Date: Feb. 1, 2024

(54) FAN AND SCROLL HOUSING FOR FAN

(71) Applicant: ZIEHL-ABEGG SE, Kunzelsau (DE)

(72) Inventors: Frieder LOERCHER, Braunsbach (DE); Alexander HEROLD, Hardthausen (DE); Matthias GOELLER, Weissbach (DE)

(21) Appl. No.: 18/257,238

(22) PCT Filed: Nov. 25, 2021
(86) PCT No.: PCT/DE2021/200205

§ 371 Date: Jun. 13, 2023

(30) Foreign Application Priority Data
Dec. 17, 2020 (DE) 10 2020 216 155.0

(51) Int. Cl. F04D 29/42; F04D 17/08; F04D 25/06

(52) U.S. Cl. CPC F04D 29/4226; F04D 17/08; F04D 25/06

(57) ABSTRACT

A fan having an impeller comprising blades, an electric motor driving the impeller, and a scroll housing, wherein a flow channel is formed by the inner contour of the scroll housing, wherein an inlet nozzle, designed as a rotating body in an embodiment, is provided on the inflow side, and wherein the flow channel guides the air aspirated by the inlet nozzle via the impeller to an outlet, is characterized in that the inlet nozzle is surrounded by an inflow area having an inflow surface, which expands the inlet nozzle essentially in the radial direction, i.e., transversely to the impeller axis. A scroll housing is designed accordingly.

### CROSS-REFERENCE TO RELATED APPLICATIONS

This application is a national stage entry application under 35 U.S.C. 371 of PCT Patent Application No. PCT/DE2021/200205, filed on Nov. 25, 2021, which claims priority to German Patent Application No. 10 2020 216 155.0, filed on Dec. 17, 2020, the entire contents of each of which are incorporated herein by reference.

### FIELD

The disclosure relates to a fan having an impeller including blades, an electric motor driving the impeller, and a scroll housing, wherein a flow channel is formed by the inner contour of the scroll housing, wherein an inlet nozzle, designed as a rotating body in an embodiment, is provided on the inlet side, and wherein the flow channel guides the air aspirated by the inlet nozzle via the impeller to an outlet.

### BACKGROUND

Fans having scroll housings are widely used, in particular for forward-curved radial and diagonal fans. Increasingly, scroll housings are also being used for backward-curved fans. Practical experience has shown that the use of a scroll housing results in an additional pressure increase and an accompanying increase in static efficiency. Scroll housings are capable of efficiently directing the outflowing air downstream of the fan impeller into a flow channel extending approximately orthogonally to the fan axis, for example into a tube having a round or square cross section.

Centrifugal or diagonal fans, in particular when the impeller is installed in a scroll housing, often have increased noise levels, in particular when the inflow runs asymmetrically to the axis of rotation of the fan impeller. Such asymmetrical inflows can be attributed, for example, to an asymmetrical geometry in the inlet area. The scroll housings known from practice, which only have one outlet, are inherently asymmetrical with respect to the axis of rotation of the fan impeller. As a result, this asymmetry of the flow also occurs in the surroundings of the inlet area. The increased noise level is annoying.

### SUMMARY

The present disclosure is therefore based on the object of optimizing fans, which use so-called scroll housings to increase performance, with regard to noise generation. Such solutions are to be simple in construction and different from competitive fans.

The above-mentioned object is achieved with respect to the fan according to the disclosure by the features of claim 1. Accordingly, the generic fan is characterized in that the inlet nozzle is surrounded by an inflow area including an inflow surface, which widens the inlet nozzle essentially in the radial direction, i.e., transversely or in particular approximately orthogonally to the impeller axis.

According to the disclosure, it has first of all been recognized that the noise problems that occur when using scroll housings can be reduced, if not even eliminated, by expanding the inlet nozzle with an outer inflow surface, as a result of which the inlet nozzle is expanded in the radial direction, i.e., transversely or, in particular, approximately orthogonally to the impeller axis.

It has been found that the noise level, which is fundamentally increased when using scroll housings, can be reduced by designing the inflow symmetrically with respect to the axis of rotation of the fan impeller, instead of an asymmetric design, as is well known from practice. In some embodiments, it is important to avoid asymmetrical geometries in the intake area, which is achieved with the expanded inlet nozzle comprising the outer inflow surface according to the teaching according to the disclosure.

It is, in some embodiments, advantageous if the inlet nozzle, which is expanded by the inflow surface, is designed symmetrically or rotationally symmetrically to the fan axis, i.e., to the axis of rotation of the fan. The inflow area can be designed in the form of a rotating body.

It is also conceivable that the inlet nozzle expanded by the inflow area is designed symmetrically to the fan axis only in the broader sense. The expanded inlet nozzle can be equipped with a rectangular, square or polygonal (for example hexagonal), or elliptical outer contour.

The inflow area or the inflow surface can be designed to be essentially planar or flat. A conical or pyramidal surface is also conceivable.

The inflow area or the expanded inlet nozzle can extend in the radial direction up to close to the radial extension of the impeller or beyond the radial extension of the impeller, by which the inlet behavior is particularly facilitated.

In some embodiments, the inflow area can begin radially at the outer end of the inlet nozzle, for instance, where its local surface curvature has a very low value in comparison to the value of the maximum surface curvature of the inner contour of the inlet nozzle, wherein this value can be <20%, but, viewed in the radial direction, at the latest at a radial distance DR_{D} from the narrowest point of the inlet nozzle, which corresponds to the axial extension L_{D} of the expanded inlet nozzle.

In a further embodiment, the radial outer edge of the inflow area or the expanded inlet nozzle is adjoined by a transition area to the contour of the scroll housing guiding the main flow. The transition can be continuous or discontinuous, in particular rounded or edged up to sharply edged.

In a further embodiment, the inlet nozzle together with the inflow area and optionally including the transition area is an integral part of the housing, for instance an inlet-side housing half.

At this point it is to be noted that the housing halves can consist of plastic. Injection molding technology is well suited for the manufacturing.

In the interior of the scroll housing, a secondary flow channel open to the flow channel can be formed, which controls a secondary flow which, in an embodiment, flows into the impeller between the inlet nozzle and a cover plate of the impeller and which extends in the radial direction beyond the impeller. This means that the secondary flow channel cannot be strictly separated from the main flow channel. The secondary flow influences not only the air performance and the efficiency, but also the sound emission of the fan, so that a reduction of the sound emission is possible via the design of the secondary flow channel.

At least with regard to its delimitation to the outside, the secondary flow channel is formed approximately rotationally symmetrically to the fan axis, wherein the inner wall of the expanded inlet nozzle delimits the secondary flow channel to the outside.

The scroll housing according to the disclosure is characterized by the features of claim 12, namely by those features of the claimed fan that relate to the scroll housing.

In addition, the scroll housing can consist of a nozzle-side housing half and a motor-side housing half, wherein both housing halves are, in some embodiments, produced by injection molding.

The housing halves can be connected to one another via a flange-like connection area, by screws, rivets, adhesives, or clips, among others.

Furthermore, it may be advantageous if the housing halves are formed having reinforcing elements, for instance in the form of reinforcing ribs, especially since considerable pressures and pressure fluctuations can occur within the housing, which the housing has to withstand.

There are now various possibilities for advantageously designing and further developing the teaching of the present disclosure. For this purpose, reference is made, on the one hand, to the claims dependent on claims 1 and 12 and, on the other hand, to the following explanation of an exemplary embodiment of a fan according to the disclosure with reference to the drawing. In connection with the explanation of the exemplary embodiment of the disclosure with reference to the drawing, additional embodiments and refinements of the teachings are also explained in general.

### BRIEF DESCRIPTION OF THE SEVERAL VIEWS OF THE FIGURES

FIG. 1 shows a perspective view of a fan according to the disclosure having scroll housing from the inlet nozzle, and

FIG. 2 shows a schematic view of the fan according to FIG. 1 in section on a plane extending through the fan axis.

### DETAILED DESCRIPTION OF THE DISCLOSURE

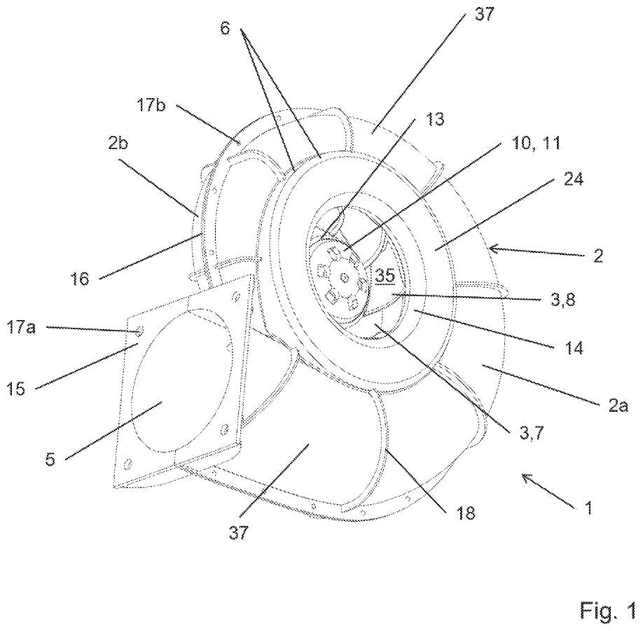

FIG. 1 shows a perspective view of a fan 1 having a scroll housing 2. The scroll housing 2 is made up of two halves, the nozzle-side half 2a and the motor-side half 2b. The two halves 2a and 2b are connected to one another at a connecting area 16. A type of flange having holes 17b, at which the halves 2a and 2b can be connected to one another by screws, is shown as the connecting area 16. Other types of connection are also conceivable, for example, by clipping, riveting, and/or adhesive bonding.

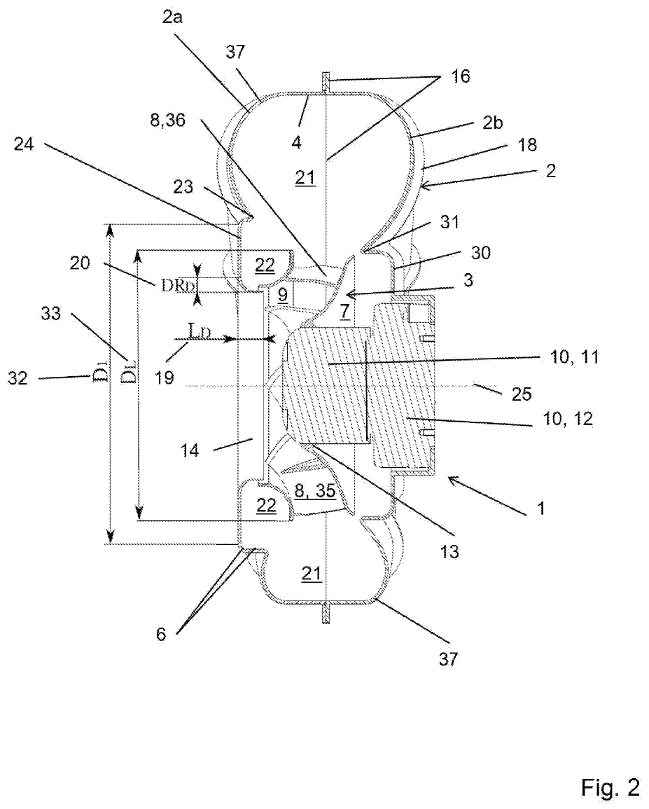

In addition to the scroll housing 2, the fan includes a motor 10 having rotor 11 and stator 12 (see FIG. 2), on which an impeller 3 consisting of a base plate 7, a cover plate 9 (see FIG. 2) and blades 8 extending in between is attached.

These halves 2a, 2b are, in an embodiment, manufactured in plastic injection molding. The inlet nozzle 14, through which the air from the surroundings flows into the impeller 3 during fan operation, is integrated in the nozzle-side half 2a. Parts of the impeller 3 (blades 8 with suction side 35 and base plate 7) as well as the rotor 11 of the motor 10, on which the impeller 3 is fastened, can be seen through the inlet nozzle 14 in FIG. 1.

An inflow surface 24 is formed radially outside of the inlet nozzle 14 on the inflow side. Viewed radially, the inflow surface 24 begins at the outer end of the inlet nozzle 14, in particular approximately where its local surface curvature assumes a very low value relative to the value of the maximum surface curvature on the inner contour of the inlet nozzle 14, for example <25%, but viewed in the radial direction at the latest at a radial distance DR_{D} 20 from the narrowest point of the inlet nozzle 14, which corresponds to the axial extension L_{D} 19 of the expanded inlet nozzle 14, 24 (see also FIG. 2). The inflow surface 24 has a very low surface curvature of at most 25% of the maximum surface curvature on the inner contour of the inlet nozzle 14 over its entire course. Its radial outer edge is characterized by the beginning of the radially adjoining transition area 6. This transition area 6 connects the inflow surface 24 to the outer contour 37 of the scroll housing 2, which guides the main flow. The beginning of the transition area 6 radially outside of the inflow surface 24 can be characterized by a sharp edge or a non-tangential transition, or else, as in the exemplary embodiment, by a rounding, which then again has a higher surface curvature than the inflow surface 24, which has a surface curvature of at most 25% of the maximum surface curvature on the inner contour of the inlet nozzle 14. The local mean surface curvature of the two main curvatures of a surface is always designated as the surface curvature here.

The transition from the inlet nozzle 14 to the inflow surface 24, in an embodiment, extends tangentially and smoothly. The inlet nozzle 14 can be viewed together with the inflow area 24 as a type of expanded inlet nozzle 14, 24. The shape of the inflow area 24 or of the expanded inlet nozzle 14, 24 is important because this area influences the distribution (seen in the radial direction and in the circumferential direction) of the flow velocities of the inflow flowing through the inlet nozzle 14 to the impeller 3. It is important for high efficiencies and low noise emissions that this inflow has a speed distribution that is as symmetrical to the axis of rotation of the impeller as possible.

It was found through tests and simulation calculations that this is best achieved by a design that is as symmetrical as possible to the axis of rotation of the impeller and a sufficient radial extension of the inflow area 24 or the expanded inlet nozzle 14, 24.

In the exemplary embodiment according to FIG. 1, the inflow area 24 or the expanded inlet nozzle 14, 24 is designed symmetrically to the axis of rotation. The inflow area 24 is even formed entirely of surfaces of revolution, which may be particularly advantageous, and the radial outer edge of the inflow area 24 has the shape of a circle concentric to the axis of rotation. The inflow area 24 in the exemplary embodiment is approximately flat over large areas and extends perpendicularly to the axis of rotation.

Other designs of the inflow area 24 or of the expanded inlet nozzle 14, 24 are also conceivable, as long as they are symmetrical to the fan axis, and in some embodiments rotationally symmetrical. This also applies to rotationally symmetrical shapes in a broader sense, such as external contours of approximately hexagonal, rectangular, square, or elliptical shape, which have rotational symmetry at least in the sense of rotations by very specific angles of rotation (which are not multiples of 360°).

The inflow surface 24 also does not necessarily have to have flat areas, it can, for example, extend conically or otherwise at an angle other than 90° to the axis of rotation.

However, a relatively large radial extension of the expanded inlet nozzle 14, 24 is also essential in order to achieve an inflow that is as uniform as possible. For example, the ring-shaped area of the expanded inlet nozzle 14, 24 projected onto a plane perpendicular to the axis of rotation is at least 1.5 times as large as the smallest flow cross-sectional area in the area of the narrowest point of the inlet nozzle 14. The radial outer edge of the inflow area 24 also extends radially outside of the impeller 3 or its cover plate 9 (see also FIG. 2).

A fastening flange 15 is formed in the area around the outlet 5 from the scroll housing 2, through which the air exits and flows into a correspondingly shaped channel. The entire fan 1 can be fastened at this flange to a surrounding structure, for example an air conditioning system or an air duct. In the exemplary embodiment, the holes 17a, to which screws can be attached, are used for this purpose. Since considerable overpressures can occur during operation in the interior of the scroll housing 2, in its flow channel 21 (see FIG. 2), in comparison to the outside environment, the two halves 2a and 2b, which are, in some embodiments, advantageously manufactured in plastic injection molding, are provided with reinforcing elements 18, reinforcing ribs 18 here, for better dimensional stability.

The impeller 3 rotates in operation, seen in the view according to FIG. 1, clockwise. It is accordingly a backward-curved impeller 3, i.e., an impeller 3 having backward-curved blades 8. In the case of backward-curved impellers 3, the blade pressure side 36 (see FIG. 2) of a blade 8, which leads the blade suction side 35 of the same blade 8 in the direction of rotation of the impeller 3 during operation, is convex, while the blade suction side 35 is concave. The blades 8 are curved and/or inclined counter the direction of rotation, in particular when considering the course of the blades 8 from radially inward (from the leading edge of the blade 8 out) to radially outward (towards the trailing edge of the blade 8).

FIG. 2 shows the fan 1 having scroll housing 2 according to FIG. 1 in a view from the side and in a section on a plane extending through the fan axis 25. On the motor-side half 2b of the housing 2, the motor 10 with its stator 12 is fastened to corresponding fastening devices integrated on the motor-side half 2b in a motor support area 30. The impeller 3, which is, in some embodiments, manufactured using plastic injection molding, is fastened to the rotor 11 of the drive motor 10 at its base plate 7 in the exemplary embodiment. In practice, there are various types of fastening, for example by adhesive bonding or by pressing on by means of a sheet metal disc cast into the plastic impeller.

When the fan is in operation, the conveyed air exits radially outwardly from the impeller 3 into the main flow channel 21 of the scroll housing 2, which extends substantially in the circumferential direction with respect to the impeller axis 25. From a narrowest point in the area of a tongue, the main flow channel 21 widens in its course in the circumferential direction, in order to accommodate the air flow increasing in the circumferential direction, towards an outlet 5 (FIG. 1) from the scroll housing 2. The main flow channel 21 is essentially delimited radially outward by an inner contour 4 defined by the outer flow contour 37.

A secondary flow channel 22, which cannot be strictly separated from the main flow channel 21, is arranged adjacent to the main flow channel 21. The flow in the secondary flow channel 22 controls a secondary flow which flows into the impeller 3 between the inlet nozzle 14 and the cover plate 9 of the impeller 3. This secondary flow significantly influences the air performance, the efficiency, and the sound emissions of the fan, which is why the design of the secondary flow area 22 is very important. It can be seen in FIG. 2 that the secondary flow channel 22 is defined to a large extent by the design of the inflow area 24 or the expanded inlet nozzle 14, 24. The contour of the wall, which defines the expanded inlet nozzle 14, 24 on the outside, borders the secondary flow area 22 on the inside. It has been shown that both the rotationally symmetrical design of the expanded inlet nozzle 14, 24, at least in the broader sense, and the relatively large radial extension of the inflow area 24 and thus the resulting, at least in the broader sense, rotationally symmetrical and radially relatively large extension of the secondary flow area 22 may also be advantageous with regard to the secondary flow described.

To characterize the radial extension of the inlet nozzle 14 or the inner edge of the inflow area 24 as seen in the radial direction, the axial extension L_{D} 19 of the expanded inlet nozzle 14, 24 and the radial distance DR_{D} 20 between the narrowest, radially innermost point of the contour of the inlet nozzle 14 and its radial outer end or the radial inner edge of the inflow area 24 are shown as dimensions in FIG. 2. Said radial distance DR_{D} is not greater than the axial extension L_{D} 19 of the expanded inlet nozzle 14,24; the inflow area 24 begins at this radial point at the latest.

To characterize the important radial extent of the expanded inlet nozzle 14, 24 and the inflow surface 24, two further dimensions are shown in FIG. 2, specifically the outer diameter D_{L} 33 of the impeller 3 at its cover plate 8 and an outer diameter D₁ of the inflow surface 24. Depending on the design of the expanded inlet nozzle 14, 24, the value of D₁ can vary over the circumference, in such a case, a value D_{1,average} averaged over the circumference or the minimum value D_{1,min} can also be used. In an embodiment, D₁ or also D_{1,average} and also D_{1,min} is greater than the impeller diameter D_{L} at the cover plate 9 of the impeller 3. In a particular embodiment, D_{1,average}>1.05*D_{L}.

It can also be seen in FIG. 2 that the inner contour 4 of the scroll housing on the motor-side half 2b is delimited radially on the inside by a pressure-side transition contour 31 which merges into the integrated motor support area 30. At this transition area 31, the inner contour 4 approximately represents an imaginary continuation of the base plate 7 of the impeller 3 radially further outwards, and there is only a relatively small distance between the radial outer edge of the base plate 7 and the inner edge of the spiral contour 4. The inner contour 4 of the scroll housing on the nozzle-side half 2b is delimited radially on the inside by the suction-side transition contour 23, which borders the transition area 6 radially on the inside, which in the further course in turn borders the expanded inlet nozzle 14, 24 radially on the inside.

It can also be seen that the cross section of the main flow channel 21 is significantly smaller in the lower area in the view than in the upper area in the view. The cross section of the main flow channel 21 expands in the circumferential direction, in the flow direction, or in the direction of rotation of the impeller 3, from a narrowest cross section in the area of a tongue towards the outlet 5 (see FIG. 1). In contrast, the flow cross section of the secondary flow channel 22 seen over the circumference changes less or periodically with a periodicity angle, seen in the circumferential direction around the axis 25, of <=180°. This is directly related to the design of the expanded inlet nozzle 14, 24, which is symmetrical to the axis 25. A cross section of a secondary flow channel 22 that changes only slightly in the circumferential direction, at most periodically, has an advantageous effect on the secondary flow that flows into the impeller 3 between the inlet nozzle 14 and the cover plate 9 and thus on the air performance, efficiency, and acoustics of the fan.

In FIG. 2, the axially compact design of the scroll housing 2 and thus the fan 1 can be seen well. The expanded inlet nozzle 14, 24 or the inflow area 24 does not protrude axially beyond the outercontour 37 of the scroll housing 2 for guiding the main flow, i.e., the extended inlet nozzle 14, 24 does not cause the need for a larger axial installation space than due to the outer contour 37 of the scroll housing 2 necessary in any case. Such a compact design is advantageous, in particular when using such a fan in ventilation devices for controlled living space ventilation, also in order to possibly maximize the inflow space between the expanded inlet nozzle 14, 24 and a wall of the ventilation device spaced apart therefrom and to ensure good inflow conditions. In order to achieve this, the axial height L_{D} 19 of the expanded inlet nozzle 14, 24 is relatively low, in particular less than 15% of the outer diameter D_{L} 33 of the impeller 3 at its cover plate 9.

To avoid repetition with regard to further embodiments of the teaching according to the disclosure, reference is made to the general part of the description and to the appended claims.

Finally, it is to be expressly noted that the above-described exemplary embodiments of the teaching according to the disclosure merely serve to discuss the claimed teaching, but do not restrict it to the exemplary embodiments.

### LIST OF REFERENCE SIGNS

1 fan
2 scroll housing, housing
2a nozzle-side half of the scroll housing/housing
2b motor-side half of the scroll housing/housing
3 impeller
4 inner contour/scroll contour
5 outlet
6 transition area
7 base plate of the impeller
8 blades of the impeller
9 cover plate of the impeller
10 motor
11 rotor of the motor
12 stator of the motor
13 fastening impeller-motor
14 inlet nozzle
15 fastening flange
16 connecting area
17a holes
17b holes
18 reinforcing element, reinforcing rib
19 axial height L_{D} of the expanded inlet nozzle
20 radial distance between the narrowest cross section of the inlet nozzle and the radial outer end of the inlet nozzle or the radial inner end of the inflow surface
21 main flow channel in the scroll housing
22 secondary flow channel in the scroll housing
23 suction-side transition contour
24 inflow surface
25 fan axis
30 integrated motor support area
31 pressure-side transition contour
32 outer diameter dimension D₁ of the inflow surface 24
33 outer diameter of the impeller 3 at the cover plate 9
35 blade suction side
36 blade pressure side
37 outer contour of the scroll housing to guide the main flow

1. A fan having an impeller having blades, an electric motor driving the impeller, and a scroll housing, wherein a flow channel is formed by the inner contour of the scroll housing, wherein an inlet nozzle is provided on the inlet side, and wherein the flow channel guides the air aspirated by the inlet nozzle via the impeller to an outlet, comprising:
the inlet nozzle being surrounded by an inflow area comprising an inflow surface, which inflow area expands the inlet nozzle essentially in the radial direction, i.e., transversely to the impeller axis.

2. The fan according to claim 1, wherein the inlet nozzle (14) expanded by the inflow area (24) is symmetrical or rotationally symmetrical to the fan axis (axis of rotation of the fan).

3. The fan according to claim 2, wherein the in-flow area is designed in the form of a rotating body.

4. The fan according to claim 1, wherein the inlet nozzle (14) expanded by the inflow area (24) is symmetrical to the fan axis in the broader sense, preferably having a rectangular, square, polygonal (for example hexagonal), or elliptical outer contour.

5. The fan according to claim 1, wherein the inflow area is essentially planar or flat, conical or pyramidal.

6. The fan according to claim 1, wherein the inflow area extends in the radial direction up to close to a radial extension of the impeller or preferably beyond the radial extension of the impeller.

7. The fan according to claim 1, wherein the inflow area (24), when viewed radially, begins at the outer end of the inlet nozzle (14), preferably where its local surface curvature has a very low value in comparison to the value of the maximum surface curvature at the inner contour of the inlet nozzle, preferably less than 20%.

8. The fan according to claim 1, wherein the radial outer edge of the inflow area (24) is adjoined by a transition area (6) to the contour (37) of the scroll housing (2) guiding the main flow, wherein the transition area can be continuous or discontinuous, rounded or edged.

9. The fan according to claim 8, wherein the inlet nozzle (14) together with the inflow area (24) and possibly the transition area (6) is/are an integral part of the housing, preferably of an inflow-side housing half.

10. The fan according claim 1, wherein a secondary flow channel (22) is formed in the interior of the scroll housing, which is open to the flow channel and controls a secondary flow which preferably flows into the impeller between the inlet nozzle (14) and a cover plate (9) of the impeller and which extends in the radial direction beyond the impeller.

11. The fan according to claim 10, wherein at least with regard to its delimitation to the outside, the secondary flow channel is formed approximately rotationally symmetrically to the fan axis, wherein the inner wall of the expanded inlet nozzle delimits the secondary flow channel to the outside.

12. A scroll housing for a fan according to claim 1.

13. The scroll housing according to claim 11, wherein it consists of a nozzle-side housing half and a motor-side housing half.

14. The scroll housing according to claim 13, wherein the two housing halves are connected to one another via a flange-like connection area, preferably by screws, rivets, adhesives, or clips.

15. The scroll housing according to claim 13, wherein the housing halves are formed having reinforcing elements, preferably in the form of reinforcing ribs.

16. The scroll housing according to claim 1, wherein the inlet nozzle is designed as a rotating body.
